(19) United States
(12) Patent Application Publication
(10) Pub. No.: US 2011/0115608 A1
(43) Pub. Date: May 19, 2011

(54) RFID TAG COMMUNICATING APPARATUS

(75) Inventors: Takuya Nagai, Nagoya-shi (JP); Kazunari Taki, Nagoya-shi (JP); Hidehisa Shiomi, Nara-shi (JP)

(73) Assignee: BROTHER KOGYO KABUSHIKI KAISHA, Nagoya-shi (JP)

(21) Appl. No.: 12/776,793

(22) Filed: May 10, 2010

Related U.S. Application Data
(63) Continuation-in-part of application No. PCT/JP2008/068312, filed on Oct. 8, 2008.

(30) Foreign Application Priority Data
Nov. 9, 2007 (JP) 2007-292627

(51) Int. Cl. G06K 7/01

(52) U.S. Cl. 340/10.1

(57) ABSTRACT

An RFID tag communicating apparatus transmitting a transmission signal to a predetermined RFID tag and receiving a return signal returned from the RFID tag with a plurality of antennas to communicate information with the RFID tag, includes an information communication control portion that executes the process for narrowing down the RFID tags to be objects of a second communication continued from a first communication based on a result of the first communication with the RED tags; and a received signal processing portion that separates return signals from a plurality of RFID tags included in received signals based on the received signals received by the plurality of the antennas in accordance with a predefined relationship, the first communication being performed in parallel with a plurality of the RFID tags, the information communication control portion narrowing down the RFID tags to be the objects of the second communication when the received signal processing portion separates the return signals from a plurality of the RFID tags included in the received signal corresponding to the first communication if it is determined that the number of the RFID tags is greater than maximum number of return signals separable by the received signal processing portion.

### CROSS REFERENCE TO RELATED APPLICATION

The present application is a Continuation-in-Part of International Application No. PCT/JP2008/068312 filed Oct. 8, 2008, which claims the benefits of Japanese Patent Application No. 2007-292627 filed Nov. 9, 2007, the disclosure of which is herein incorporated by reference in its entirety.

### TECHNICAL FIELD

The present invention relates to an RFID tag communicating apparatus performing communication with an RFID tag capable of wirelessly writing and reading information and, particularly, to improvement for communicating information with a plurality of RFID tags in parallel.

### BACKGROUND ART

An RFID (Radio Frequency Identification) system is known that reads information without contact with a predetermined RFD tag communicating apparatus (interrogator) from a small RFID tag (responder) storing predetermined information. Since even if an RFID tag is contaminated or disposed at blind spot, information stored in the RFID tag is readable through communication with an RFID tag communicating apparatus, the RFID system is expected to be practically used in various fields such as commodity management and inspection operation.

The RFID tag communicating system communicating information with a plurality of RFID tags through the RFID tag communicating apparatus has a defect that information becomes unreadable due to crosstalk occurring in the RFID tag communicating apparatus since the responses from a plurality of the RFD tags are generated in parallel (at the same time). Therefore, a technique (mobile object identifying apparatus) is proposed for resolving the defect. In this technique, for a RFID tag communicating apparatus (interrogator) that includes a communication request signal generating portion that generates a plurality of communication request signals and an intercommunication determining portion that selects a communicatable RFID tag in accordance with a response request among a plurality of RFID tags (responders) received in a plurality of time slots synchronized with communication start request signals generated by the communication request signal generating portion, by varying the number of the time slots with the intercommunication determining portion in accordance with the number of RFID tags within an intercommunication area, it is considered that reliable communication operation with a plurality of RFID tags is achievable.

### DISCLOSURE OF THE INVENTION

### Problems to be Solved by the Invention

However, the conventional technique requires relatively long time for communication with the RFID tags to select a communicatable RFID tag and has an adverse effect that the occurrence of crosstalk is not sufficiently prevented. Since the interrogation wave transmitted from the RFID tag communicating apparatus generally has the same frequency as the response waves of RFID tags and the response waves from a plurality of RFID tags are unable to be separated by frequency and an effective separating method does not exist, a problem may occur such as being unable to read the response wave of the RFID tag. Therefore, it is required to develop an RFID tag communicating apparatus capable of communicating information with a plurality of RFID tags in parallel.

The present invention was conceived in view of the background and it is therefore the object of the present invention to provide an RFID tag communicating apparatus capable of communicating information with a plurality of RFID tags in parallel.

### Means for Solving the Problems

The object indicated above is achieved in the present invention, which provides an RFID tag communicating apparatus transmitting a transmission signal to a predetermined RFID tag and receiving a return signal returned from the RFID tag with a plurality of antennas to communicate information with the RFID tag, including: an information communication control portion that executes the process for narrowing down the RFID tags to be objects of a second communication continued from a first communication based on a result of the first communication with the RFID tags; and a received signal processing portion that separates return signals from a plurality of RFID tags included in received signals based on the received signals received by the plurality of the antennas in accordance with a predefined relationship, the first communication being performed in parallel with a plurality of the RFID tags, the information communication control portion narrowing down the RFID tags to be the objects of the second communication when the received signal processing portion separates the return signals from a plurality of the RFID tags included in the received signal corresponding to the first communication if it is determined that the number of the RFID tags is greater than maximum number of return signals separable by the received signal processing portion.

### EFFECTS OF THE INVENTION

According to the present invention, the apparatus includes an information communication control portion that executes the process for narrowing down the RFID tags to be objects of a second communication continued from a first communication based on a result of the first communication with the RFID tags; and a received signal processing portion that separates return signals from a plurality of RFID tags included in received signals based on the received signals received by the plurality of the antennas in accordance with a predefined relationship, the first communication being performed in parallel with a plurality of the RFID tags, the information communication control portion narrowing down the RFID tags to be the objects of the second communication when the received signal processing portion separates the return signals from a plurality of the RFID tags included in the received signal corresponding to the first communication if it is determined that the number of the RFID tags is greater than maximum number of return signals separable by the received signal processing portion. Consequently, the information communication may be continued in a preferable manner with a plurality of the RFID tags by narrowing down the RFID tags to be the objects in the second communication continued from the first communication even if the responses from the RFID tags of the inseparable number are made in parallel in the first communication. The RFID tag communicating apparatus may be provided that may perform the information communication in parallel with a plurality of the RFID tags.

Preferably, the received signal processing portion evaluates independency of a plurality of received signal components at least partially overlapping in both a frequency domain and a time domain to separate return signals from a plurality of RFID tags included in the received signals based on the evaluation result. Consequently, the received signal having a mixture of the return signals from a plurality of the RFID tags at least partially overlapping in both the frequency domain and the time domain may be separated into the components.

Preferably, the received signal processing portion is capable of separating the return signals from the RFID tags up to the number same as the antennas included in the RFID tag communicating apparatus. Consequently, the return signals from a plurality of the RFID tags included in the received signals received by the plurality of the antennas may be separated in a preferable manner by the received signal processing portion and the information communication may be performed in parallel with the largest number of the RFID tags.

Preferably, the received signal processing portion is capable of separating the return signals from the RFID tags up to the number reduced by one from the number of the antennas included in the RFID tag communicating apparatus. Consequently, the return signals from a plurality of the RFID tags included in the received signals received by the plurality of the antennas may be separated in the received signal processing portion, and, furthermore, an error in the weight may be detected when there are the responses from the RFID tags equal to or greater than the number of a plurality of the antennas and the information communication may be preferably performed in parallel with a plurality of the RFID tags.

Preferably, the information communication control portion narrows down the RFID tags to be the objects of the communication by controlling a command included in the transmission signal. Consequently, the RFID tags to be the objects of the communication may be narrowed down in a practical aspect.

Preferably, the apparatus includes a transmission directionality control portion that controls transmission directionality of the transmission signal, and the information communication control portion narrows down the RFID tags to be the objects of the communication by controlling the transmission directionality of the transmission signal with the transmission directionality control portion. Consequently, the RFID tags to be the objects of the communication may be narrowed down in a practical aspect.

Preferably, the apparatus includes a transmission directionality control portion that controls transmission directionality of the transmission signal, and the information communication control portion narrows down the RFID tags to be the objects of the communication by controlling a command included in the transmission signal and by controlling the transmission directionality of the transmission signal with the transmission directionality control portion. Consequently, the RFID tags to be the objects of the communication may be narrowed down in a practical aspect.

Preferably, the information communication control portion first narrows down the RFID tags to be the objects of the communication by controlling the transmission directionality of the transmission signal with the transmission directionality control portion and then narrows down the RFID tags to be the objects of the communication by controlling the command included in the transmission signal. Consequently, the RFID tags to be the objects of the communication may be narrowed down in a practical aspect.

Preferably, the information communication control portion performs the first communication through a command for reading a portion of identification information stored in the RFID tags. Consequently, the second communication may be performed in a preferred manner for further reading the identification information from the RFID tags corresponding to the identification information based on the portion of the identification information read in the first communication.

Preferably, the information communication control portion first performs the first communication through a command for reading a portion of identification information stored in the RFID tags and then performs the second communication through a command for reading the entire identification information stored in the RFID tags based on a result of the first communication. Consequently, the second communication may be performed in a preferred manner based on a portion of the identification information read in the first communication to read the entire identification information from the RFID tags corresponding to the identification information.

Preferably, the received signal processing portion whitens the received signals received by the plurality of the antennas and normalizes and orthogonalizes a restoring matrix determined based on the whitened signals to separate the return signals from a plurality of the RFID tags as independent components included in the received signals. Consequently, the return signals from a plurality of the RFID tags included in the received signals received by the plurality of the antennas may be separated in a practical aspect.

### BRIEF DESCRIPTION OF DRAWINGS

FIG. 1 is a diagram for explaining an RFID tag communicating system to which the present invention is applied in a preferred manner.

FIG. 2 is a diagram for explaining a configuration of the RFID tag communicating system of one embodiment of the invention

FIG. 3 is a diagram for explaining a configuration of an RFID tag circuit element included in an RFID tag that is a communication object of the RFID tag communicating apparatus of FIG. 2.

FIG. 4 is a diagram for explaining a basic ICA model that is a reference of signal separation by the RFID tag communicating apparatus of FIG. 2.

FIG. 5 is a diagram for explaining an example of communication with a plurality of RFID tags in a conventional technique.

FIG. 6 is a diagram for explaining an example of communication with a plurality of RFID tags by the RFID tag communicating apparatus of FIG. 2.

FIG. 7 is a flowchart for explaining a relevant part of tag enumeration control of a DSP of the RFID tag communicating apparatus of FIG. 2.

FIG. 8 is a flowchart for explaining a relevant part of Ping control in the control of FIG. 7.

FIG. 9 is a flowchart for explaining a relevant part of Wait calculation control in the control of FIG. 8.

FIG. 10 is a flowchart for explaining a relevant part of signal separation process in the control of FIG. 8.

FIG. 11 is a diagram for explaining another example of communication with a plurality of RFID tags by the RFID tag communicating apparatus of FIG. 2.

FIG. 12 is a flowchart for explaining a relevant part of the tag enumeration control of the DSP of the RFID tag communicating apparatus of FIG. 2, corresponding to the control of FIG. 11.

FIG. 13 is a flowchart for explaining a relevant part of scroll ID control in the control of FIG. 12.

FIG. 14 is a diagram for explaining a further example of communication with a plurality of RFID tags by the RFID tag communicating apparatus of FIG. 2.

FIG. 15 is a flowchart for explaining a relevant part of the tag enumeration control of the DSP of the RFID tag communicating apparatus of FIG. 2, corresponding to the control of narrowing down RFID tags that are communication objects by changing transmission directionality.

### EXPLANATIONS OF LETTERS OR NUMERALS

10: RFID tag communicating system, 12: RFID tag communicating apparatus, 14: RFID tag, 16: DSP, 18: antenna, 20: transmitting/receiving circuit, 22: carrier wave output portion, 24: transmission data multiplying portion, 25: transmission phase sifting portion, 26: transmission amplifying portion, 28: transmission/reception separating portion, 30: filter, 32: cancel phase sifting portion, 34: cancel amplifying portion, 36: cancel combining portion, 38: demodulating portion, 40: reception amplifying portion, 42: reception filter, 44: reception A/D converting portion, 50: information communication control portion, 52: transmission data generating portion, 54: received signal processing portion, 56: protocol engine, 58: weight calculating portion, 60: signal separating portion, 62: transmission directionality control portion, 64: memory portion, 70: RFID tag circuit element, 72: antenna portion, 74: IC circuit portion, 76: rectifying portion, 78: power source portion, 80: clock extracting portion, 82: memory portion, 84: modulating/demodulating portion, 86: control portion

### BEST MODES FOR CARRYING OUT THE INVENTION

Preferred embodiments of the present invention will now be described with reference to the drawings.

### Embodiments

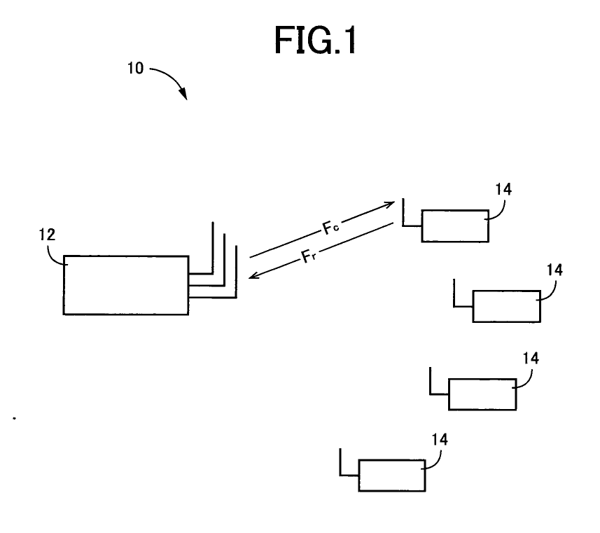

An RFID tag communicating system 10 of FIG. 1 is a so-called RFID (Radio Frequency Identification) system made up of an RFID tag communicating apparatus 12 that is an embodiment of a first aspect of the present invention and one or a plurality of (in FIG. 1, four) RFID tags 14 that are communication objects of the RFID tag communicating apparatus 12, and the RFID tag communicating apparatus 12 and the RFID tags 14 act as an interrogator and responders, respectively, of the RFID system. When the RFID tag communicating apparatus 12 transmits an interrogation wave F_{c} (transmission signal) to the RFID tags 14, the interrogation wave F_{c} is modulated with a predetermined information signal (data) and returned as a response wave Fᵣ (return signal) by the RFID tag 14 receiving the interrogation wave F_{c} to communicate information between the RFID tag communicating apparatus 12 and the RFID tag 14. The RFID tag communicating system 10 is used for management of goods within a predetermined communication area, for example, and the RFID tags 14 are preferably integrally provided on the goods by affixing to the goods to be managed, etc.

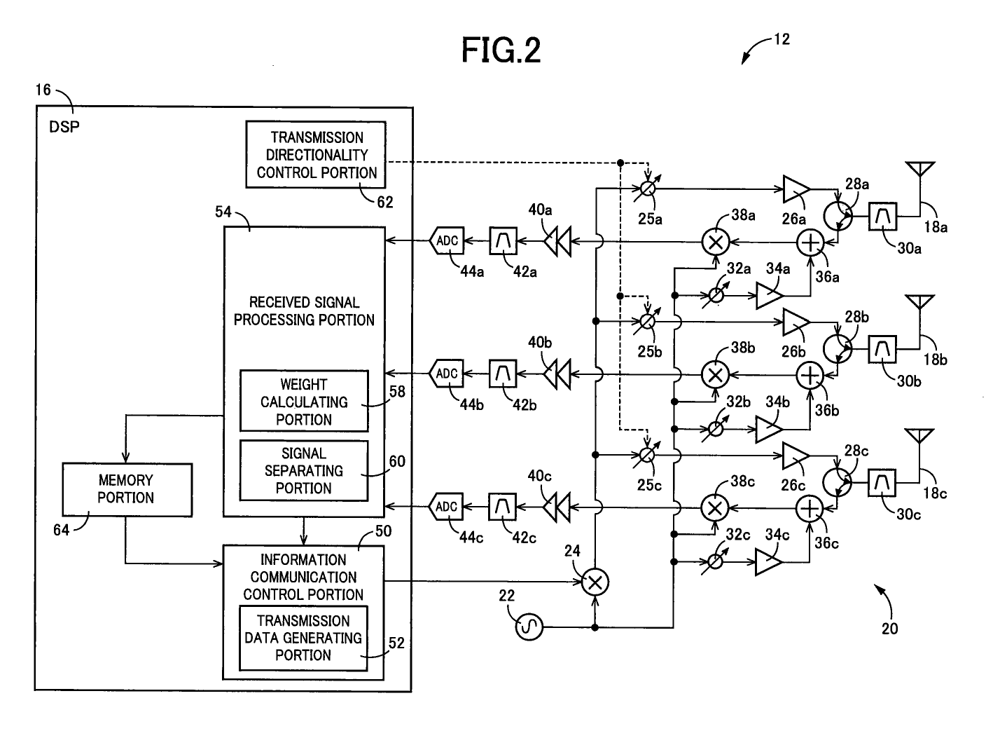

As depicted in FIG. 2, the RFID tag communicating apparatus 12 of the embodiment communicates information to read/write information from/to the RFID tags 14 and to detect directions, etc., of the RFID tags 14 and is made up of a DSP (Digital Signal Processor) 16 that executes digital signal processes such as outputting transmission data as a digital signal and reading response data from the RFID tag 14 based on a return signal from the RFID tag 14, a plurality of (in FIG. 2, three) antennas 18a, 18b, 18c (hereinafter, simply referred to as antennas 18 if not particularly distinguished) used for both the transmission of the interrogation wave F_{c} and the reception of the response wave Fᵣ, and a transmitting/receiving circuit 20 that executes a transmission process for transmitting the interrogation wave F_{c} from at least one antenna 18 of a plurality of the antennas 18 and that executes a reception process for a received signal received with a plurality of the antennas 18.

The transmitting/receiving circuit 20 includes a carrier wave output portion 22 that outputs a predetermined frequency signal corresponding to the carrier wave of the interrogation wave F_{c}; a transmission data multiplying portion 24 that multiplies the frequency signal output from the carrier wave output portion 22 by transmission data supplied from the DSP 16; a plurality of (in FIG. 2, three) transmission phase shifting portions 25a, 25b, 25c that control the phases of the signals output from the transmission data multiplying portion 24 in accordance with an instruction value supplied from the DSP 16 correspondingly to the antennas 18 (hereinafter, simply referred to as transmission phase shifting portions 25 if not particularly distinguished); a plurality of (in FIG. 2, three) transmission amplifying portions 26a, 26b, 26c that amplify the signal output from the transmission phase shifting portions 25 (hereinafter, simply referred to as transmission amplifying portions 26 if not particularly distinguished); a plurality of (in FIG. 2, three) transmission/reception separating portions 28a, 28b, 28c that supply the signal output from the transmission amplifying portions 26 to the antennas 18 and that supply the received signals received by the antennas 18 to cancel combining portions 36 described later (hereinafter, simply referred to as transmission/reception separating portions 28 if not particularly distinguished); a plurality of (in FIG. 2, three) filters 30a, 30b, 30c provided in signal transfer paths between the transmission/reception separating portions 28 and the antennas 18 (hereinafter, simply referred to as filters 30 if not particularly distinguished); a plurality of (in FIG. 2, three) cancel phase sifting portions 32a, 32b, 32c that control the phase of the frequency signal output from the carrier wave output portion 22 correspondingly to the antennas 18 (hereinafter, simply referred to as cancel phase sifting portions 32 if not particularly distinguished); a plurality of (in FIG. 2, three) cancel amplifying portions 34a, 34b, 34c that amplify the signals output from the cancel phase sifting portions 32 (hereinafter, simply referred to as cancel amplifying portions 34 if not particularly distinguished); a plurality of (in FIG. 2, three) cancel combining portions 36a, 36b, 36c that combines the cancel signals output from the cancel amplifying portions 34 with the received signals received by the antennas 18 and supplied through the filters 30 and the transmission/reception separating portions 28 (hereinafter, simply referred to as the cancel combining portions 36 if not particularly distinguished); a plurality of (in FIG. 2, three) demodulating portions 38a, 38b, 38c that multiply the signals output from the cancel combining portions 36 by the frequency signal output from the carrier wave output portion 22 to perform demodulation (hereinafter, simply referred to as demodulating portions 38 if not particularly distinguished); a plurality of (in FIG. 2, three) reception amplifying portions 40a, 40b, 40c that amplify the signals output from the demodulating portions 38 (hereinafter, simply referred to as reception amplifying portions 40 if not particularly distinguished); a plurality of (in FIG. 2, three) reception filters 42a, 42b, 42c that allow passage of signals in a predetermined frequency bands only among the signals output from the reception amplifying portions 40 (hereinafter, simply referred to as reception filters 42 if not particularly distinguished); and a plurality of (in FIG. 2, three) reception A/D converting portions 44a, 44b, 44c that convert and supply the signals output from the reception filters 42 into digital signals to the DSP 16 (hereinafter, simply referred to as reception A/D converting portions 44 if not particularly distinguished).

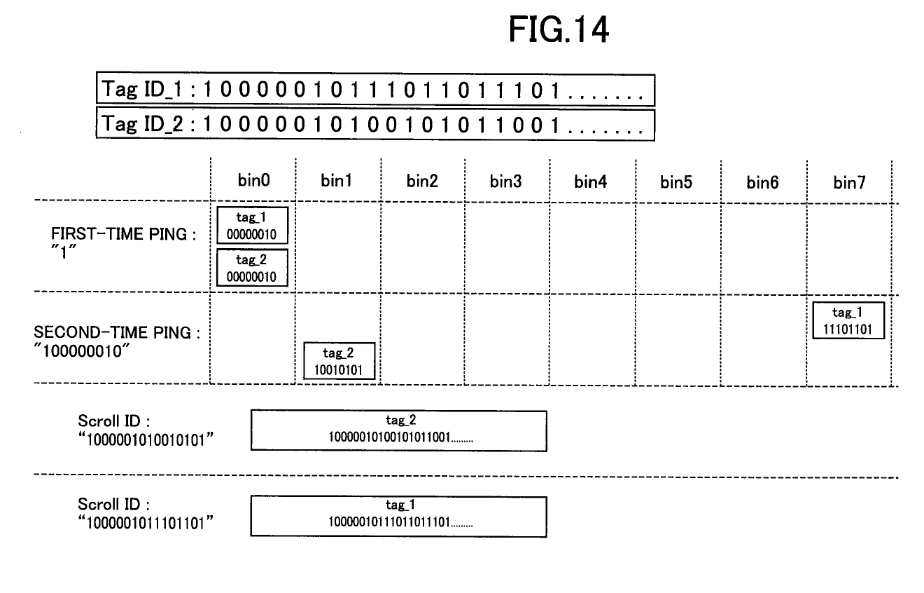

The DSP 16 is a so-called microcomputer made up of CPU, ROM, RAM, etc., to execute signal processes in accordance with programs preliminarily stored in the ROM while utilizing a temporary storage function of the RAM and includes an information communication control portion 50, a received signal processing portion 54, and a transmission directionality control portion 62 as control functions for performing the information communication control with the RFID tags 14, the direction detection control for the RFID tags 14, etc. These control functions will be described later with reference to FIGS. 4 to 16. The DSP 16 includes a memory portion 64 for storing information related to the process of received signals by the received signal processing portion 54.

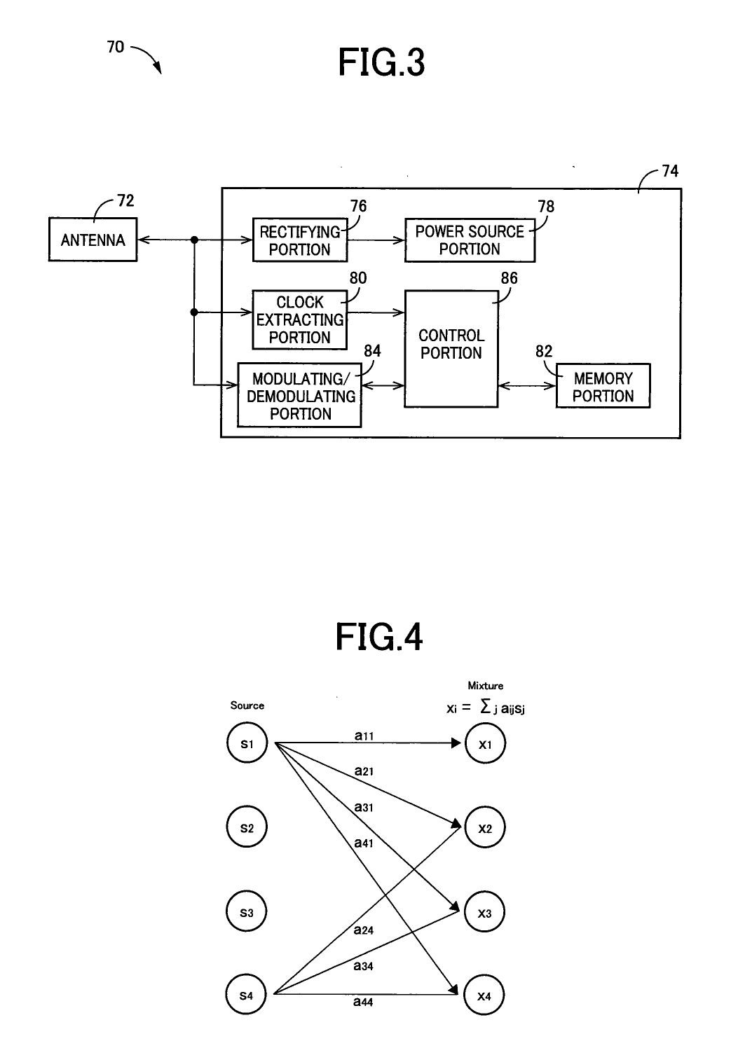

As depicted in FIG. 3, an RFID tag circuit element 70 includes an antenna portion 72 for transmitting/receiving signals to/from the RFID tag communicating apparatus 12 and an IC circuit portion 74 connected to the antenna portion 72 to execute an information communication process with the RFID tag communicating apparatus 12. The IC circuit portion 74 functionally includes a rectifying portion 76 that rectifies the interrogation wave F_{c} received by the antenna portion 72 from the RFID tag communicating apparatus 12, a power source portion 78 for accumulating the energy of the interrogation wave F_{c} rectified by the rectifying portion 76, a clock extracting portion 80 that extracts and supplies a clock signal from the carrier wave received by the antenna portion 72 to a control portion 86, a memory portion 82 that acts as an information storage portion that may store predetermined information signals, a modulating/demodulating portion 84 connected to the antenna portion 72 to modulate and demodulate signals, and the control portion 86 for controlling the operation of the RFID tag circuit element 70 through the rectifying portion 76, the clock extracting portion 80, the modulating/demodulating portion 84, etc. The control portion 86 performs basic controls such as control for storing the predetermined information into the memory portion 82 by performing communication with the RFID tag communicating apparatus 12 and control for demodulating and reflecting/returning the interrogation wave F_{c} received by the antenna portion 72 based on the information signal stored in the memory portion 82 as the response wave Fᵣ from the antenna portion 72 by the modulating/demodulating portion 84.

Returning to FIG. 2, the information communication control portion 50 included in the DSP 16 of the RFID tag communicating apparatus 12 controls the communication of information with the RFID tags 14 by the RFID tag communicating apparatus 12. Specifically, control is performed for a transmission signal transmitted to the RFID tag 14 that is the communication object. To perform such control of the transmission signal, a transmission data generating portion 52 is included. The transmission data generating portion 52 generates, for example, a predetermined bit string (transmission bit string) as transmission data to the RFID tag 14 and encodes and supplies the generated bit string with the FSK mode, etc., to the transmission data multiplying portion 24. The transmission data generated by the transmission data generating portion 52 is carried by the carrier wave output from the carrier wave output portion 22 from the transmission data multiplying portion 24 and is transmitted as a transmission signal through the transmission phase shifting portion 25, the transmission amplifying portion 26, the transmission/reception separating portion 28, and the filter 30 to the RFID tag 14 from the antennas 18.

The received signal processing portion 54 processes the received signal received with a plurality of the antennas 18 to read the response data from the RFID tag 14. Specifically, the signal supplied from the reception A/D converting portion 44 is decoded in the FSK mode, etc., and the decoded signal is interpreted to read the information signal (response data) related to the demodulation of the RFID tag 14. The received signal processing portion 54 executes a signal separation process of separating the return signals from a plurality of RFID tags 14 included in the received signal based on the received signal received with a plurality of the antennas 18 in accordance with a predefined relationship. To execute the signal separation process, the weight calculating portion 58 and the signal separating portion 60 are included. An example will hereinafter be described for a specific method of the signal separation process by the weight calculating portion 58 and the signal separating portion 60.

The signal separating portion 60 applies an appropriate weight (load) calculated by the weight calculating portion 58 to cause interference to separate a return signal from each of the RFID tags 14 from collision signals received by a plurality of the antennas 18, i.e., received signals including a mixture of the return signals from a plurality of the RFID tags 14. Assuming that x, s, A, and y denote a received signal of each antenna, a signal of each tag, a channel matrix, and an estimated output signal, a relationship represented by the following Eq. (1) is satisfied. Determining an appropriate weight is equivalent to determining W satisfying y=s when only x is known. One method for determining such an appropriate weight is a method using an independent component analysis (ICA) algorithm that separates signals with attention focused on the independence of signal. In this embodiment, the ICA algorithm is used for determining the appropriate weight. The ICA algorithm breaks down a probability variable into a linear combination of statistically independent variables as represented by Eq. (2). In this equation, ξ=(ξ₁, ξ₂, . . . ξₙ)^{T}, ζⱼ, and aⱼ=(a₁ⱼ, a₂ⱼ, . . . a_{Mj})^{T} denote a probability variable vector, an independent variable, and a combination coefficient vector, respectively. Eq. (2) is hereinafter referred to as a basic ICA model and the relationship thereof is depicted in FIG. 4. The statistical independence is defined as follows and if the combination probability density function p_{12 . . . M} of the probability variables ζⱼ is representable by the product of the marginal probability density function pⱼ as represented by Eq. (3), the probability variables ζⱼ are independent of each other.

y(t)=Wx(t)=WAs(t) (1)

ξ(t)=a₁ζ₁(t)+a₂ζ₂(t)+ . . . +a_{M}ζ_{M}(t) (2)

p(ζ₁, ζ₂ . . . ζ_{M})=p₁(ζ₁)p₂(ζ₂) . . . p_{M}(ζ₄) (3)

Many ICA algorithms determine a combination coefficient wᵢ that forms the linear combination yⱼ of the probability variables xᵢ with the highest independence from each other. The following Eq. (4) represents yⱼ. In this equation, y=(y₁, y₂ . . . y_{N})^{T} denotes an estimation vector and wᵢ=(w₁ᵢ, w₂ᵢ . . . w_{Mi})^{T} denotes a restoring vector. Except the order and the variance, yⱼ acquired from Eq. (4) is identical to sⱼ. When a matrix representative of the arbitrary property is denoted by Q, a relationship of y=Qs is satisfied. The operation of maximizing the statistic independence of yⱼ requires a reference for measuring the independence. In the central limit theorem of the statistical theory, the density distribution of probability variables consisting of a mixture of a multiplicity of independent components comes closer to the Gaussian distribution as the number of the independent components increases. Therefore, an amount for determining how far the distribution of yⱼ is away from the Gaussian distribution is preferable as a reference for measuring the independence. Negentropy closely related to information entropy is often used as a reference for determining how far certain probability variable distribution is away from the Gaussian distribution. The following Eq. (5) represents the negentropy of complex probability variable. In this equation, J(x), xgauss, and H(x)=−∫px(y)logpx(y)dy denote negentropy for the probability variable x, arbitrary probability variable indicative of the Gaussian distribution, and entropy for the probability variable x, respectively. Negentropy is always nonnegative and indicates zero if the probability variable distribution is sufficiently close to the Gaussian distribution.

y(t)=w₁x₁(t)+w₂x₂(t)+ . . . +w_{N}x_{N}(t) (4)

J(x)=H(xgauss)−H(x) (5)

Many ICA algorithms determine the restoring vector wⱼ by using a gradient method and a fixed point method defining an independence reference as a cost function. A complex value using negentropy, fast ICA is the most common technique (see E. Bingham and A. Hyvarinen, “A fast fixed-point algorithm for independent component analysis of complex-valued signals,” Int. J. of Neural Systems, 10(1):1-8, 2000). Generally describing the algorithm, first, z is calculated which is a whitened observation signal x at a first calculating step. At a second calculating step, after a restoring matrix W=(w₁, w₂ . . . w_{M})^{T} is initialized by a random number element, the eigenvalue expansion is performed for orthogonalization. At a third calculation step, the following fourth and fifth calculating steps are repeated until δW, i.e., a variation of the restoring matrix is sufficiently reduced. At a fourth calculating step, the following Eq. (6) is updated with W. At this point, g(x)=tan h(x) and g′(x)=1+tan h(x) are satisfied. At a fifth calculating step, the updated W is normalized and orthogonalized. As above, the restoring vector wⱼ is determined by the first to fifth calculating steps. The estimation vector y may be represented by the following Eq. (7) with a matrix product of a complex conjugate transpose matrix W^{H} and a whitened observation signal z.

W←E{z(W^{H}z)*g(|W^{H}z|²)}−E{g(|W^{H}z|²)+|W^{H}z|²g′(|W^{H}z|²)} (6)

y(t)=W^{H}z(t) (7)

The blind signal separation is an issue of estimating source signals only from results xᵢ observed at a plurality of points mixed by different mixing coefficients in an environment receiving the arrival of mixed signals sⱼ emitted from a multiplicity of signal sources. If the source signals are statically independent of each other, this issue basically comes down to an ICA model and, therefore, the source signals may be estimated by processing the observed signals with the independent component analysis. As above, the received signal processing portion 54 determines the resolving matrix W defined based on a whitened signal such that the elements of the estimated output signal y become statistically independent of each other to separate return signals s from a plurality of the RFID tags 14 as independent components included in the received signal as the observation result x. In other words, the independence is evaluated for a plurality of received signals x at least partially overlapping in both the frequency domain and the time domain and the return signals s from a plurality of the RFID tags 14 included in the received signals x are separated based on the evaluation result. A weight calculated by the weight calculating portion 58 in the signal separation process is stored in the memory portion 64. The received signal processing portion 54 may perform preliminary signal processes such as Fourier transformation and wavelet transform and adjustment such as optimization of a cost function, in addition to the method described above.

In the received signal process of this embodiment described in detail above, independent components may be separated up to the number same as the antennas 18 included in the RFID tag communicating apparatus 12. The RFID tag communicating apparatus 12 of this embodiment may perform communication in parallel with the RFID tags 14 up to the same number as the antennas 18 included in the RFID tag communicating apparatus 12. To acquire accurate output signals with the orthogonality of the estimated output signals ensured, it may be conceivable that the communication may be performed in parallel with the RFID tags up to the number reduced by one from the number of the antennas 18 included in the RFID tag communicating apparatus 12.

The information communication control portion 50 utilizes the received signal process (signal separation process) by the received signal processing portion 54 to perform the communication control for communicating information with a plurality of the RFID tags 14 in parallel, especially, for reading IDs of the RFID tags 14. In the communication control, a first communication is performed with a plurality of the RFID tags 14 in parallel through a command, i.e., a “PING” command, for reading a portion of identification information (ID) stored in the RFID tags 14 and, in accordance with the result of the communication, a second communication is performed with a plurality of the RFID tags that are the communication objects in parallel for reading IDs from the RFID tags 14. The information communication control by the information communication control portion 50 with a plurality of the RFID tags 14 will hereinafter be described in detail.

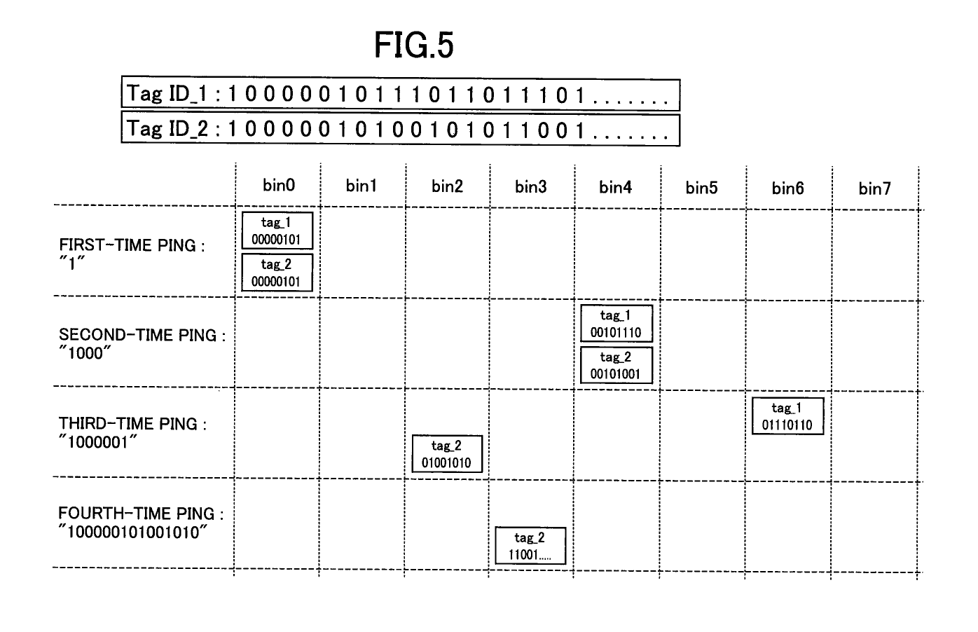

In an example depicted in FIG. 5, for the first (first-time) communication, the RFID tag communicating apparatus 12 transmits a transmission signal corresponding to the “PING” command specifying “1”. In response to the transmission signal corresponding to the “PING:‘1’” command, at “bin0”, the first RFID tag 14 (hereinafter, Tag1) returns a return signal corresponding to “00000101”, which is an eight-bit value following “1” at the head of the ID of the Tag 1, and the second RFID tag 14 (hereinafter, Tag2) returns a return signal corresponding to “00000101”, which is an eight-bit value following “1” at the head of the ID of the Tag 2. In conventional techniques, if the return signals from a plurality of the RFID tags 14 overlap and mix in both the frequency domain and the time domain in this way, since the return signals is unable to be separated from each other, no ID of the RFID tags 14 may be read in the first communication and only a three-bit value (in this example, “000”) known from the bin number is determined to perform the second communication. In the second (second-time) communication, the RFID tag communicating apparatus 12 transmits a transmission signal corresponding to the “PING” command specifying “1000”. In response to the transmission signal corresponding to the “PING:‘1000’” command, at “bin4”, the Tag1 returns a return signal corresponding to “00101110”, which is an eight-bit value following “1000” at the head of the ID of the Tag 1, and the Tag2 returns a return signal corresponding to “00101001”, which is an eight-bit value following “1000” at the head of the ID of the Tag 2, and since the return signals from a plurality of the RFID tags 14 mix as is the case with the first communication, no ID of the RFID tags 14 may be read and only a three-bit value (in this example, “001”) known from the bin number is determined to perform third-time communication. In the third-time communication, the RFID tag communicating apparatus 12 transmits a transmission signal corresponding to the “PING” command specifying “1000001”. In response to the transmission signal corresponding to the “PING: ‘1000001’” command, at “bin6”, the Tag 1 returns a return signal corresponding to “01110110”, which is an eight-bit value following “1000001” at the head of the ID of the Tag 1 and, at “bin2”, the Tag2 returns a return signal corresponding to “01001010”, which is an eight-bit value following “1000001” at the head of the ID of the Tag 2. The RFID tag communicating apparatus 12 is able to receive eight-bit values returned from the RFID tags 14 at this timing for the first time and to determine the next communication command by using these values. In a fourth-time communication, the RFID tag communicating apparatus 12 transmits a transmission signal corresponding to the “PING” command specifying “100000101001010” and, in response to the transmission signal corresponding to the “PING:‘100000101001010’” command, at “bin3”, the Tag2 returns a return signal corresponding to “11001 . . . ”, which is an eight-bit value following “100000101001010” at the head of the ID of the Tag 2. Since the return signals included in the received signal are unable to be separated in the received signal having a mixture of the return signals from a plurality of the RFID tags 14 as above in the reading process (tag enumeration process) for a plurality of the RFID tags 14 with conventional techniques, if the responses from a plurality of the RFID tags 14 are returned at the same “bin”, the communication must be performed again and a relatively long time is required for reading the IDs of all the RFID tags 14.

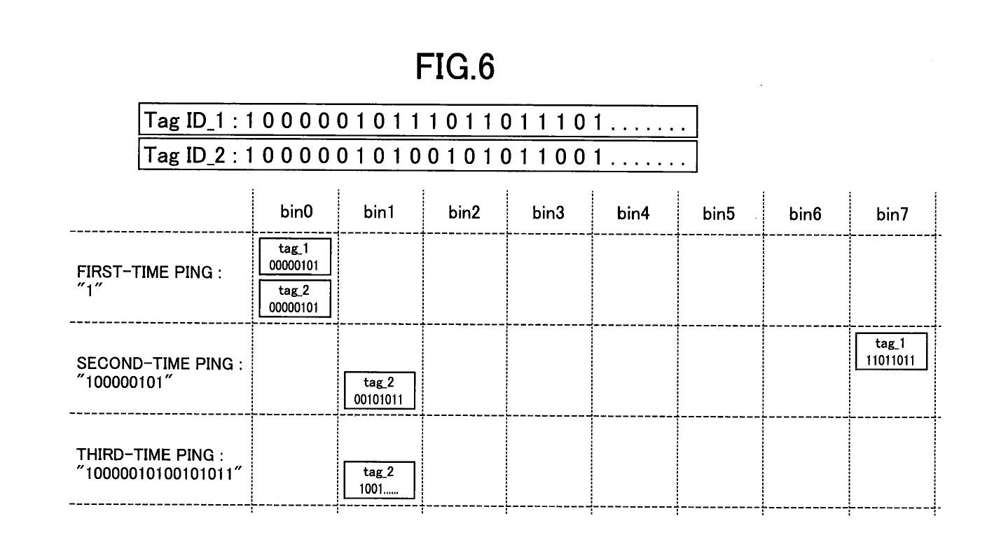

In an example depicted in FIG. 6, for the first (first-time) communication, the RFID tag communicating apparatus 12 transmits a transmission signal corresponding to the “PING” command specifying “1”. In response to the transmission signal corresponding to the “PING:‘1’” command, at “bin0”, the Tag1 returns a return signal corresponding to “00000101”, which is an eight-bit value following “1” at the head of the ID of the Tag 1, and the Tag2 returns a return signal corresponding to “00000101”, which is an eight-bit value following “1” at the head of the ID of the Tag 2. The return signals from the Tag1 and the Tag2 are received by the plurality of the antennas 18 as a signal having a mixture of the return signals and are separated into the signal components of the Tag1 and the Tag2 by the received signal processing portion 54 to read eight-bit values corresponding to the signals. In the second (second-time) communication, the RFID tag communicating apparatus 12 transmits a transmission signal corresponding to the “PING” command specifying “100000101” commonly read from the Tag1 and the Tag2 in the first-time communication. In response to the transmission signal corresponding to the “PING:‘100000101’” command, at “bin7”, the Tag1 returns a return signal corresponding to “11011011”, which is an eight-bit value following “100000101” at the head of the ID of the Tag 1, and the Tag2 returns a return signal corresponding to “00101011”, which is an eight-bit value following “100000101” at the head of the ID of the Tag 2. In the third-time communication, the RFID tag communicating apparatus 12 transmits a transmission signal corresponding to the “PING” command specifying “10000010100101011” read from the Tag2 and, in response to the transmission signal corresponding to the “PING:‘10000010100101011’” command, at “bin1”, the Tag2 returns a return signal corresponding to “1001 . . . ”, which is an eight-bit value following “10000010100101011” at the head of the ID of the Tag 2. Since the return signals included in the received signal are able to be separated in the received signal having a mixture of the return signals from a plurality of the RFID tags 14 as above in the reading process (tag enumeration process) for a plurality of the RFID tags 14 by the RFID tag communicating apparatus 12 of the embodiment, if the responses from a plurality of the RFID tags 14 are returned at the same “bin”, the received signal is separated into the components corresponding to the individual RFID tags 14 and the separated return signals (response data) may be interpreted to reduce the number of times of transmission of the “PING” command and to reduce the time required for reading the IDs of all the RFID tags 14.

When the communication is first performed in parallel with a plurality of the RFID tags 14 and the received signal processing portion 54 separates the return signals from a plurality of the RFID tags 14 included in the received signal corresponding to the first communication, if it is determined that the number of the RFID tags 14 is greater than the maximum number of the return signals separable by the received signal processing portion 54, the information communication control portion 50 performs the control for narrowing down the RFID tags 14 to be the objects of the next communication. The narrow-down control is preferably performed by controlling a command included in the transmission signal, i.e., transmission data generated by the transmission data generating portion 52. For example, if it is determined that a mixture is formed by the return signals from the RFID tags 14 of the number greater than the maximum number separable by the received signal processing portion 54 in the communication corresponding to a certain “PING” command, the foremost bit string of the “PING” command is changed in the next communication to narrow down the RFID tags 14 to be the objects of the communication. The narrow-down control is preferably performed by controlling the transmission directionality of the transmission signal with the transmission directionality control portion 62. For example, if it is determined that a mixture is formed by the return signals from the RFID tags 14 of the number greater than the maximum number separable by the received signal processing portion 54 in the communication corresponding to certain transmission directionality, the transmission directionality is changed by the transmission directionality control portion 62 in the next communication to narrow down the RFID tags 14 to be the objects of the communication.

The information communication control portion 50 preferably performs the control for narrowing down the RFID tags 14 to be the objects of the communication by controlling a command included in the transmission signal with the transmission data generating portion 52 and by controlling the transmission directionality of the transmission signal with the transmission directionality control portion 62. For example, if it is determined that a mixture is formed by the return signals from the RFID tags 14 of the number greater than the maximum number separable by the received signal processing portion 54 in the communication corresponding to a certain “PING” command and corresponding to certain transmission directionality, the first bit string of the “PING” command as well as the transmission directionality are changed in the next communication to narrow down the RFID tags 14 to be the objects of the communication. More preferably, after the transmission directionality of the transmission signal is first controlled by the transmission directionality control portion 62 to narrow down the RFID tags 14 to be the objects of the communication, the command included in the transmission signal is controlled by the transmission data generating portion 52 to narrow down the RFID tags 14 to be the objects of the communication.

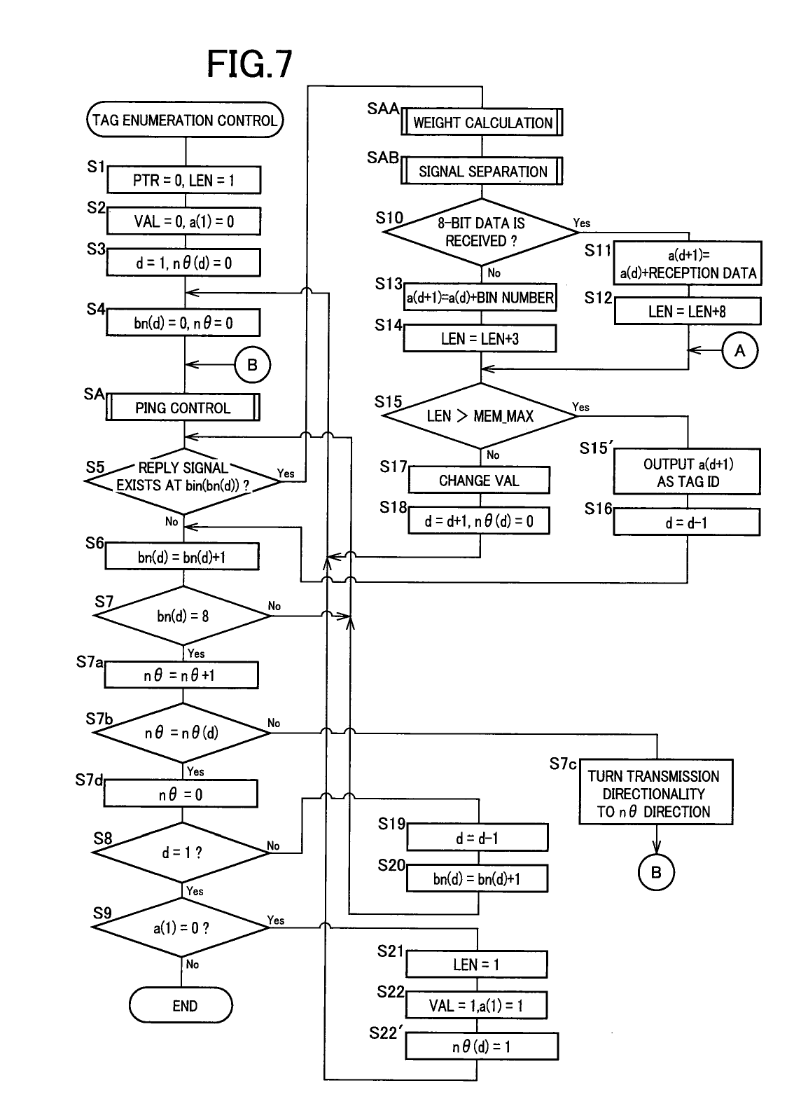

A flowchart of FIG. 7 is repeatedly executed at predetermined intervals.

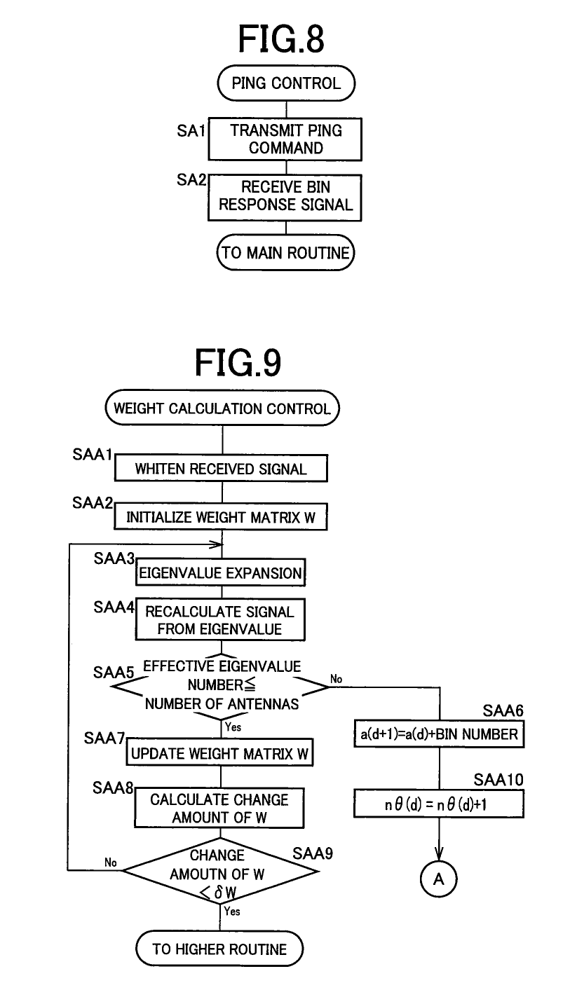

First, at step (hereinafter, step is omitted) S1, “PTR=0” and “LEN=1” are set. At S2, “VAL=0” and “a(1)=0”, i.e., a value of detection data are set. At S3, a value “d=1” indicative of the number of times of the “PING” command and a transmission direction division number “nθ(d)=0” are set. At S4, “bn(d)=0” is set, which is the bin number at “d” set at S3, and a transmission direction number “nθ=0” is set. At SA, the Ping control depicted in FIG. 8 is performed. At S5, it is determined whether a replay signal exists at “bin(bn(d))”. If the determination at S5 is positive, the process from SAA is executed and If the determination at S5 is negative, “1” is added to the bin number “dn(d)” at S6. At S7, it is determined whether the bin number “bn(d)” is “8”, which is the total number of the bin intervals. If the determination at S7 is negative, the process from S5 is executed again and if the determination at S7 is positive, after “1” is added to the transmission direction number “nθ” at S7a, it is then determined at S7b whether “nθ” is identical to “nθ(d)”. If the determination at S7b is negative, after the transmission directionality is turned to the “nθ” direction at S7d, the process from SA is executed and if the determination at S7b is positive, after “nθ” is set to “0”, it is determined at S8 whether “d” indicative of the number of times of the “PING” command is “1”. If the determination at S8 is negative, after “1” is subtracted from “d” at S19 and “1” is added to “bn(d)” at S20, the process from S5 is executed again and if the determination at S8 is positive, since all the same parts of the foremost data of the memory portion 70 are identified, it is determined at S9 whether the value of the foremost data flag “a” is “0”. If the determination at S9 is positive, after “LEN=1” is set at S21; “VAL=1” is set and the detection data value is set to “a(1)=1” at S22; and the transmission direction division number “nθ(d)=0” is set at S22′, the process from S4 is executed again and if the determination at S9 is negative, this terminates the routine.

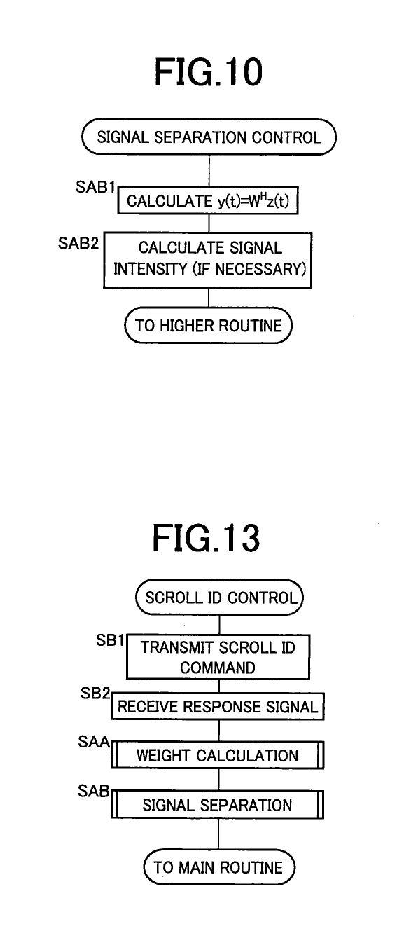

At SAA, the weight calculation control depicted in FIG. 9 is executed. After the signal separation control depicted in FIG. 10 is performed at SAB, it is determined at S10 whether eight-bit data is received from the certain RFID tag 14. If the determination at S10 is positive, after “a(d+1)” is newly prepared by adding eight-bit data as the received data to the detection data value “a(d)” at S11 and eight is added to the length of “LEN” at S12, the process from S15 is executed and if the determination at S10 is negative, after the bin number is added to the detection data value “a(d)” to obtain “a(d+1)” at S13 and three is added to the length of “LEN” at S14, it is determined at S15 whether the length of “LEN” is greater than the total storage number “MEM_MAX” of the memory portion 64. If the determination at S15 is positive, after the value of “a(d+1)” is output as the tag ID at S15′ and “1” is subtracted from “d” at S16, the process from S6 is executed and if the determination at S15 is negative, the value of “VAL” is changed based on the data discriminated by the “PING” commands executed until last time at S17. Then at S18 “1” is added to “d” and “nθ(d)” is set to “1”, the process from S4 is executed again.

In the control of FIG. 8, first, at SA1, the “PING” command corresponding to the set foremost bit string is generated and transmitted from the antenna 18 through the transmission data multiplying portion 24, etc. After receiving the return signals (BIN response) returned from the RFID tags 14 in response to the transmission signal transmitted at SA1 with the plurality of the antennas 18 at SA2, the control is returned to the tab enumeration control depicted in FIG. 7.

In the control of FIG. 9, first, at SAA1, a whitening process is executed for the received signals received with the plurality of the antennas 18. At SAA2, a weight matrix W determined based on the signals whitened at SAA1 is initialized. At SAA3, the eigenvalue expansion is performed for the received signals based on the weight matrix W initialized at SAA2. At SAA4, signals are recalculated from the eigenvalues expanded at SAA3. At SAA5, it is determined whether the calculated effective eigenvalue number is equal to or less than the number of the antennas 18. If the determination at SAA5 is negative, after the bin number for narrowing down the RFID tags 14 to be the communication objects is added to “a(d)” to obtain “a(d+1)” at SAA6 and “1” is added to the directionality division number “nθ(d)”, the control is returned to the process from S15 of FIG. 7 described above and if the determination at SAA5 is positive, the update process of the weight matrix W is executed at SAA7. At SAA8, a change amount of the weight matrix W is calculated. At SAA9, it is determined whether the change amount of the weight matrix W calculated at SAA8 is smaller than a predetermined value δW. If the determination at SAA9 is negative, the process from SAA3 is executed again and if the determination at SAA9 is positive, this returns the control to SA10 depicted in FIG. 8. Although it is determined whether the effective eigenvalue number is equal to or less than the number of the antennas 18 in the process of SAA5, it may be determined whether the effective eigenvalue number is equal to or less than the number reduced by one from that of the antennas 18. In this case, an error in the effective eigenvalues may be detected that occurs when the effective eigenvalues equal to or greater than the number of the antennas are obtained.

In the control of FIG. 10, first, at SAB1, y(t)=W^{H}z(t) is calculated based on the weight matrix derived in the weight calculation control of FIG. 9. After the signal intensities of the separated return signals corresponding to the RFID tags 14 are calculated as needed at SAB2, the control is returned to the Ping control depicted in FIG. 8. In the control, S1 to S22, SA1, SA2, and SAA6 correspond to the operation of the information communication control portion 50 and SAA and SAB correspond to the operation of the received signal processing portion 54.

Since this embodiment includes the information communication control portion 50 (S1 to S22, SA1, SA2, and SAA6) that executes the process for narrowing down the RFID tags 14 to be the objects of the second communication continued from the first communication based on the result of the first communication with the RFID tags 14 and the received signal processing portion 54 (SAA and SAB) that separates the return signals from a plurality of the RFID tags 14 included in the received signal based on the received signal received by a plurality of the antennas 18 with a predefined relationship and since the information communication control portion 50 narrows down the RFID tags 14 to be the objects of the second communication when the first communication is performed in parallel with a plurality of the RFID tags 14 and the received signal processing portion 54 separates the return signals from a plurality of the RFID tags 14 included in the received signal corresponding to the first communication if it is determined that the number of the RFID tags 14 is greater than the maximum number of return signals separable by the received signal processing portion 54, the information communication may be continued in a preferable manner with a plurality of the RFID tags 14 by narrowing down the RFID tags 14 to be the objects in the second communication continued from the first communication even if the responses from the RFID tags 14 of the inseparable number are made in parallel in the first communication. The RFID tag communicating apparatus 12 may be provided that may perform the information communication in parallel with a plurality of the RFID tags 14.

Since the received signal processing portion 54 evaluates the independence of a plurality of received signal components at least partially overlapping in both the frequency domain and the time domain and separates the return signals from a plurality of the RFID tags 14 included in the received signal based on the evaluation result, the received signal having a mixture of the return signals from a plurality of the RFID tags 14 at least partially overlapping in both the frequency domain and the time domain may be separated into the components.

Since the received signal processing portion 54 may separate the return signals from the RFID tags 14 up to the number same as the antennas 18 included in the RFID tag communicating apparatus 12, the return signals from a plurality of the RFID tags 14 included in the received signals received by the plurality of the antennas 18 may be separated in a preferable manner by the received signal processing portion 54 and the information communication may be performed in parallel with the largest number of the RFID tags 14.

Since the received signal processing portion 54 may separate the return signals from the RFID tags 14 up to the number reduced by one from the number of the antennas 18 included in the RFID tag communicating apparatus 12, the return signals from a plurality of the RFID tags 14 included in the received signals received by the plurality of the antennas 18 may be separated in a more preferable manner by the received signal processing portion 54 because an error in effective eigenvalues may be detected that occurs when the effective eigenvalues equal to or greater than the number of a plurality of the antennas 18 are obtained and the information communication may be performed in parallel with a plurality of the RFID tags 14.

Since the information communication control portion 50 narrows down the RFID tags 14 to be the objects of the communication by controlling a command included in the transmission signal, the RFID tags 14 to be the objects of the communication may be narrowed down in a practical aspect.

Since the information communication control portion 50 performs the first communication through a “PING” command that is a command for reading a portion of identification information stored in the RFID tags 14, the second communication may be performed in a preferred manner for further reading the identification information from the RFID tags 14 corresponding to the identification information based on the portion of the identification information read in the first communication.

Since the received signal processing portion 54 whitens the received signals received by the plurality of the antennas 18 and normalizes and orthogonalizes the restoring matrix W determined based on the whitened signals to separate the return signals from a plurality of the RFD tags 14 as independent components included in the received signals, the return signals from a plurality of the RFID tags 14 included in the received signals received by the plurality of the antennas 18 may be separated in a practical aspect.

Since the transmission directionality control portion 62 (S7c) controlling the transmission directionality of the transmission signal is included and the information communication control portion 50 narrows down the RFID tags 14 to be the objects of the communication by controlling the transmission directionality of the transmission signal with the transmission directionality control portion 62, the RFID tags 14 to be the objects of the communication may be narrowed down in a practical aspect.

Since the information communication control portion 50 narrows down the RFID tags 14 to be the objects of the communication by controlling the command included in the transmission signal with the transmission data generating portion 52 and by controlling the transmission directionality of the transmission signal with the transmission directionality control portion 62, the RFID tags 14 to be the objects of the communication may be narrowed down in a practical aspect.

Since the information communication control portion 50 first narrows down the RFID tags 14 to be the objects of the communication by controlling the transmission directionality of the transmission signal with the transmission directionality control portion 62 and then narrows down the RFID tags 14 to be the objects of the communication by controlling the command included in the transmission signal with the transmission data generating portion 52, the RFID tags 14 to be the objects of the communication may rapidly be narrowed down in a practical aspect.

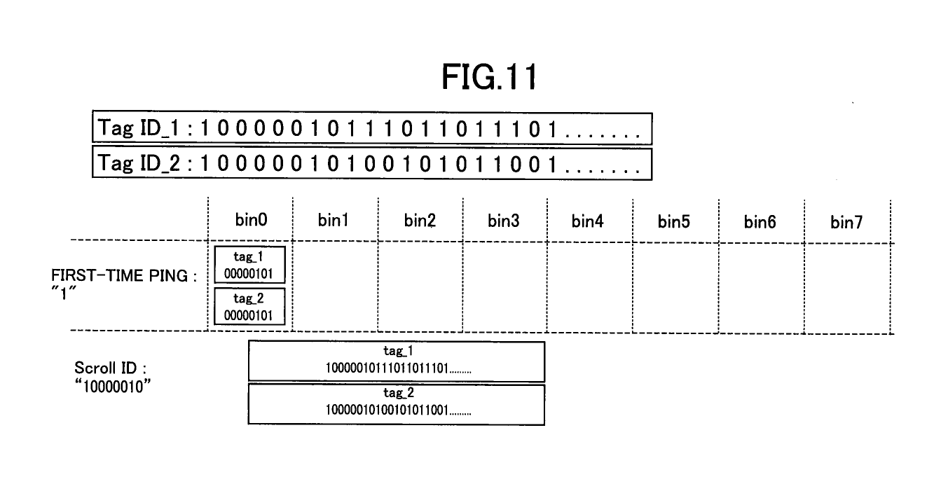

As depicted in FIG. 11, the information communication control portion 50 preferably first performs the first communication through a command, i.e., a “PING” command, for reading a portion of identification information stored in the RFID tags 14 and then performs the second communication through a command, i.e., a “Scroll ID” command, for reading the entire identification information stored in the RFID tags 14 based on the result of the first communication. For example, in an example depicted in FIG. 11, for the first (first-time) communication, the RFID tag communicating apparatus 12 transmits a transmission signal corresponding to the “PING” command specifying “1”. In response to the transmission signal corresponding to the “PING: ‘1’” command, at “bin0”, the Tag1 returns a return signal corresponding to “00000101”, which is an eight-bit value following “1” at the head of the ID of the Tag 1, and the Tag2 returns a return signal corresponding to “00000101”, which is an eight-bit value following “1” at the head of the ID of the Tag 2. The return signals from the Tag1 and the Tag2 are received by a plurality of the antennas 18 as a signal having a mixture of the return signals and separated by the received signal processing portion 54 into the signal components of the Tag 1 and the Tag2 to read eight-bit values corresponding to the signals. In the second communication, the RFID tag communicating apparatus 12 transmits a transmission signal corresponding to the “Scroll ID” command specifying “10000010”, which is the foremost ID read in the first communication. In response to the transmission signal corresponding to the “PING:‘1’” command, the Tag1 returns a return signal corresponding to “10000010111011011101 . . . ”, which is the ID of the Tag 1, and the Tag2 returns a return signal corresponding to “10000010100101011001 . . . ”, which is the ID of the Tag2. The return signals from the Tag1 and the Tag2 are received by a plurality of the antennas 18 as a signal having a mixture of the return signals and separated by the received signal processing portion 54 into the signal components of the Tag1 and the Tag2 to read the IDs corresponding to the signals. In the reading process (tag enumeration process) for a plurality of the RFID tags 14 by the RFID tag communicating apparatus 12 of this embodiment, a series of the communication processes may be executed in parallel with a plurality of the RFID tags 14 such that after a portion of the identification information of the RFID tags 14 is read in the first communication, the second communication is performed to read the entire identification information of the RFID tags 14 by using the result of the first communication and, therefore, a time required for reading the IDs of all the RFID tags 14 may expeditiously be reduced.

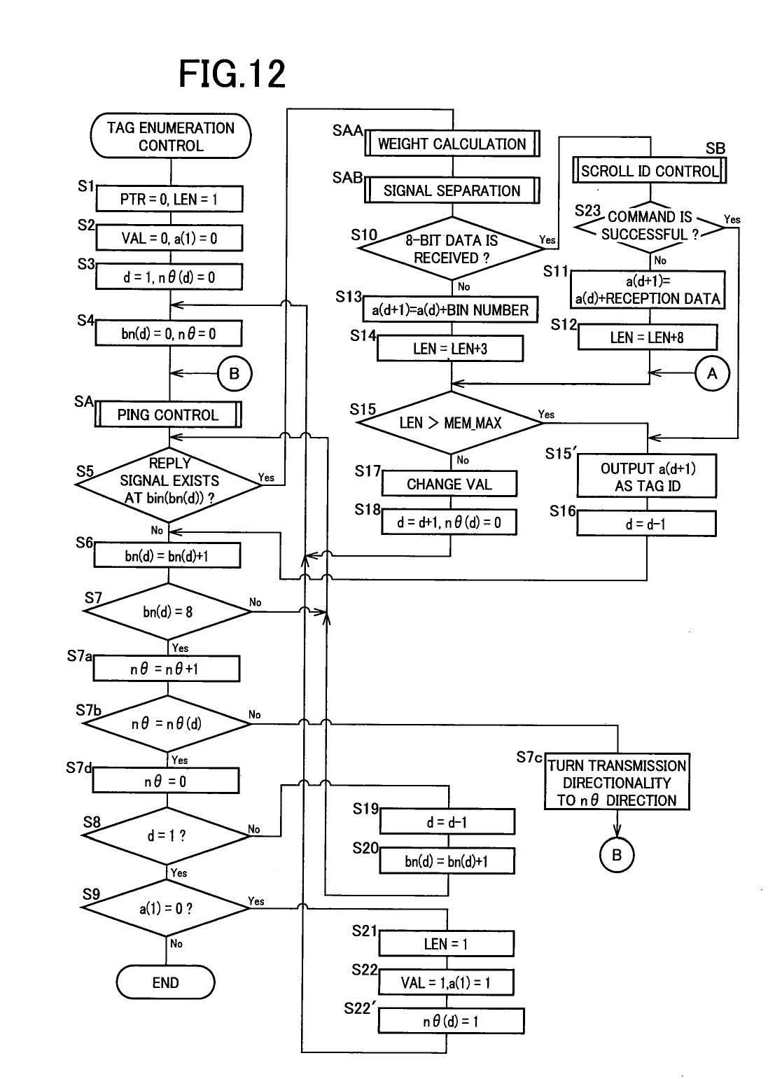

A flowchart of FIG. 12 is repeatedly executed at predetermined intervals. In this control, steps common to the control depicted in FIG. 7 are denoted by the same reference numerals and will not be described. If the determination at S10 described above is positive in the control depicted in FIG. 12, i.e., if it is determined that eight-bit data is received from a predetermined RFID tag 14, after the scroll ID control depicted in FIG. 13 is executed at SB, it is determined at S23 whether the communication through a scroll ID command is successful. If the determination at S23 is negative, the process from S11 is executed and if the determination at S23 is positive, this terminates the routine.

In the control of FIG. 13, first, at SB1, the “Scroll ID” command corresponding to a predetermined foremost bit string is generated and transmitted from the antenna 18 through the transmission data multiplying portion 24, etc. At SB2, the return signals returned from the RFID tags 14 in response to the transmission signal transmitted at SB1 are received, with the plurality of the antennas 18. At SAA, the weight calculation control depicted in FIG. 9 is executed. At SAB, after the signal separation control depicted in FIG. 10 is executed, the control is returned to the tag enumeration control depicted in FIG. 12.

According to this embodiment, since the information communication control portion 50 performs the first communication through the “PING” command that is a command for reading a portion of identification information stored in the RFID tags 14 and then performs the second communication through the “Scroll ID” command that is a command for reading the entire identification information stored in the RFID tags 14 based on a result of the first communication, the second communication may be performed in a preferred manner based on a portion of the identification information read in the first communication to read the entire identification information from the RFID tags 14 corresponding to the identification information, and the communication for reading the identification information of each of a plurality of the RFID tags 14 may be performed in parallel with the RFID tags 14.

In an example depicted in FIG. 6, for the first (first-time) communication, the RFID tag communicating apparatus 12 transmits a transmission signal corresponding to the “PING” command specifying “1”. In response to the transmission signal corresponding to the “PING: ‘1 ’” command, at “bin0”, the Tag1 returns a return signal corresponding to “0000010”, which is an eight-bit value following “1” at the head of the ID of the Tag 1, and the Tag2 returns a return signal corresponding to “00000101”, which is an eight-bit value following “1” at the head of the ID of the Tag 2. The return signals from the Tag1 and the Tag2 are received by the plurality of the antennas 18 as a signal having a mixture of the return signals and are separated into the signal components of the Tag1 and the Tag2 by the received signal processing portion 54 to read eight-bit values corresponding to the signals. In the second communication, the RFID tag communicating apparatus 12 transmits a transmission signal corresponding to the “PING” command specifying “10000010” commonly read from the Tag 1 and the Tag2 in the first-time communication. In response to the transmission signal corresponding to the “PING:‘10000010’” command, at “bin7”, the Tag1 returns a return signal corresponding to “11101101”, which is an eight-bit value following “10000010” at the head of the ID of the Tag 1, and the Tag2 returns a return signal corresponding to “10010101”, which is an eight-bit value following “10000010” at the head of the ID of the Tag 2. The RFID tag communicating apparatus 12 transmits a transmission signal corresponding to the “Scroll ID” command specifying the foremost bit string “1000001011101101” to the Tag1 to read the entire ID of the Tag 1 and transmits a transmission signal corresponding to the “Scroll ID” command specifying the foremost bit string “1000001010010101” to the Tag2 to read the entire ID of the Tag2. In response to the transmission signals corresponding to the “Scroll ID” command, the Tag1 returns a return signal corresponding to “10000010111011011101 . . . ”, which is the ID of the Tag1 and the Tag2 returns a return signal corresponding to “10000010100101011001 . . . ”, which is the ID of the Tag2. The return signals from the Tag1 and the Tag2 are received by a plurality of the antennas 18 as a signal having a mixture of the return signals and separated by the received signal processing portion 54 into the signal components of the Tag 1 and the Tag2 to read the IDs corresponding to the signals. In the reading process (tag enumeration process) for a plurality of the RFID tags 14 by the RFID tag communicating apparatus 12 of this embodiment, a series of the communication processes may be executed in parallel with a plurality of the RFID tags 14 such that after the identification information of the RFID tags 14 is read for a predetermined length from the beginning in first-time and second-time communications, the second communication is performed to read the entire identification information of the RFID tags 14 by using the results of the first-time and second-time communications and, therefore, a time required for reading the IDs of all the RFID tags 14 may be reduced.

When the first communication is performed in parallel with a plurality of the RFID tags 14 and the received signal processing portion 54 separates the return signals from a plurality of the RFID tags 14 included in the received signal corresponding to the first communication, if it is determined that the number of the RFID tags 14 is greater than the maximum number of the return signals separable by the received signal processing portion 54, the information communication control portion 50 preferably performs the control for narrowing down the RFID tags 14 to be the objects of the second communication by controlling the transmission directionality of the transmission signal with the transmission directionality control portion 62.

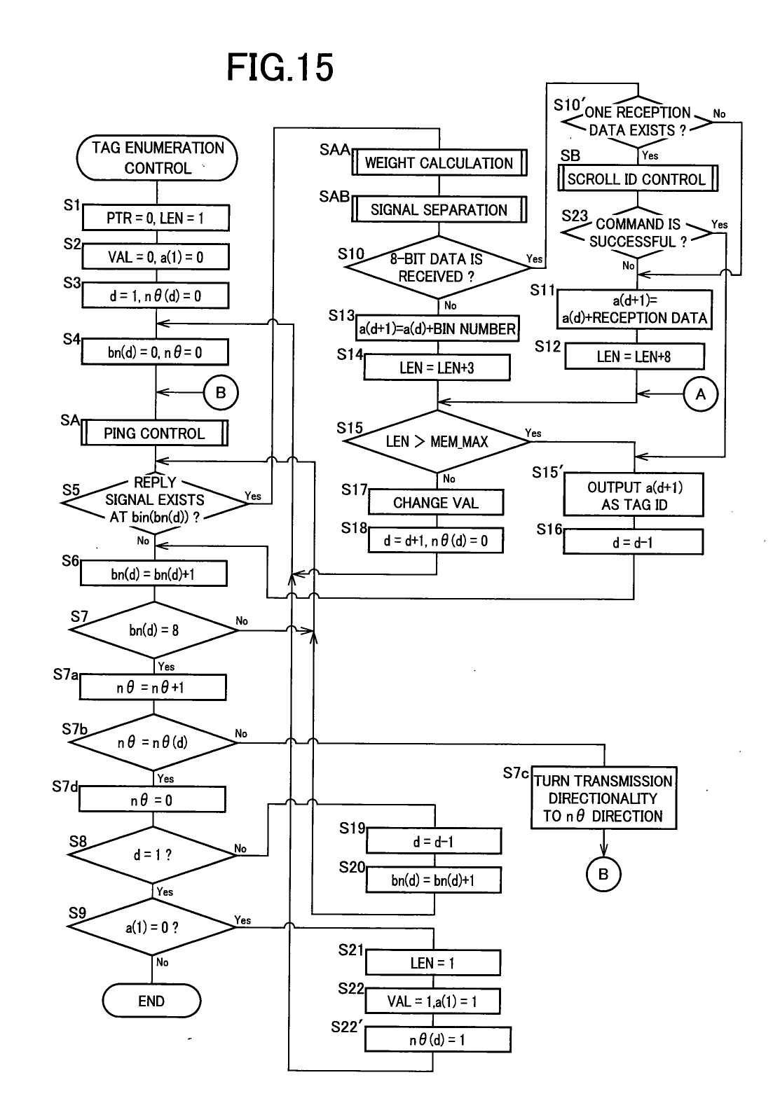

FIG. 15 is a flowchart for explaining a relevant part of the tag enumeration control by the DSP 16 of the RFID tag communicating apparatus 12 corresponding to the control of this aspect, which is repeatedly executed at predetermined intervals. In this control, steps common to the control depicted in FIG. 7, etc., are denoted by the same reference numerals and will not be described. In the control depicted in FIG. 15, if it is determined that eight-bit reception data is acquired in the process at S10, it is determined at s10′ whether one reception data exists. If the determination at S10′ is positive, the process from SB is executed and if the determination at S10′ is negative, the process from S11 is executed.

According to this embodiment, since the RFID tags 14 to be the objects of the communication are narrowed down by performing the Scroll ID control after the receiving tags are narrowed down to one tag for each bin, the RFID tags 14 to be the objects of the communication may be narrowed down in a practical aspect.

Although the preferred embodiments of the present invention have been described in detail with reference to the drawings, the present invention is not limited to this description and is implemented in other aspects.

For example, although the control functions such as the information communication control portion 50, the received signal processing portion 54, and the signal intensity detecting portion 62 are functionally included in the DSP 16 of the RFID tag communicating apparatus 12 in the embodiments, this is not a limitation of the present invention and the control devices having these control functions may individually be provided. The control by these control functions may be performed regardless of whether digital signal processes or analog signal processes.

Although the RFID tag communicating apparatus 12 includes a plurality of the antennas 18 used for both transmission and reception in the embodiments, a plurality of antennas receiving the response signals may be provided separately from one or a plurality of antennas for transmitting the transmission signals. The number of the antennas 18 is changed as needed in accordance with design, and the maximum number of the RFID tags 14 separable by the received signal processing portion 54 is determined depending on the number of the antennas 18 used for reception as described above.

Although the RFID tag communicating apparatus 12 controls only the transmission directionality of the transmission signal and does not control the reception directionality of the received signals in the embodiments, it may be conceivable that the reception directionality of an array antenna consisting of the antennas 18 may be controlled by providing a phase shifter, etc., correspondingly to the antennas 18. The RFID tags 14 to be the objects of the communication may be narrowed down only by controlling the command in the transmission signal without controlling both the transmission directionality and the reception directionality.

Although the RFID tag communicating apparatus 12 includes the cancel phase sifting portion 32, the cancel amplifying portion 34, the cancel combining portion 36, etc., as a configuration for constraining a sneak signal from the transmission side in the embodiments, these constituent elements are not necessarily be provided if the effect of the sneak signal from the transmission side is negligibly small.

Although not exemplary illustrated one by one, the present invention is implemented with various modifications within a range not departing from the spirit thereof.

What is claimed is:

1. An RFID tag communicating apparatus transmitting a transmission signal to a predetermined RFID tag and receiving a return signal returned from the RFID tag with a plurality of antennas to communicate information with the RFID tag, comprising:
an information communication control portion that executes the process for narrowing down the RFID tags to be objects of a second communication continued from a first communication based on a result of the first communication with the RFID tags; and
a received signal processing portion that separates return signals from a plurality of RFID tags included in received signals based on the received signals received by the plurality of the antennas in accordance with a predefined relationship,
the first communication being performed in parallel with a plurality of the RFID tags, the information communication control portion narrowing down the RFID tags to be the objects of the second communication when the received signal processing portion separates the return signals from a plurality of the RFID tags included in the received signal corresponding to the first communication if it is determined that the number of the RFID tags is greater than maximum number of return signals separable by the received signal processing portion.

2. The RFID tag communicating apparatus of claim 1, wherein the received signal processing portion evaluates independency of a plurality of received signal components at least partially overlapping in both a frequency domain and a time domain to separate return signals from a plurality of RFID tags included in the received signals based on the evaluation result.

3. The RFID tag communicating apparatus of claim 1, wherein the received signal processing portion is capable of separating the return signals from the RFID tags up to the number same as the antennas included in the RFID tag communicating apparatus.

4. The RFID tag communicating apparatus of claim 1, wherein the received signal processing portion is capable of separating the return signals from the RFID tags up to the number reduced by one from the number of the antennas included in the RFID tag communicating apparatus.

5. The RFID tag communicating apparatus of claim 1, wherein the information communication control portion narrows down the RFID tags to be the objects of the communication by controlling a command included in the transmission signal.

6. The RFID tag communicating apparatus of claim 1, comprising a transmission directionality control portion that controls transmission directionality of the transmission signal, wherein the information communication control portion narrows down the RFID tags to be the objects of the communication by controlling the transmission directionality of the transmission signal with the transmission directionality control portion.

7. The RFID tag communicating apparatus of claim 1, comprising a transmission directionality control portion that controls transmission directionality of the transmission signal, wherein the information communication control portion narrows down the RFID tags to be the objects of the communication by controlling a command included in the transmission signal and by controlling the transmission directionality of the transmission signal with the transmission directionality control portion.

8. The RFID tag communicating apparatus of claim 7, wherein the information communication control portion first narrows down the RFID tags to be the objects of the communication by controlling the transmission directionality of the transmission signal with the transmission directionality control portion and then narrows down the RFID tags to be the objects of the communication by controlling the command included in the transmission signal.

9. The RFID tag communicating apparatus of claim 1, wherein the information communication control portion performs the first communication through a command for reading a portion of identification information stored in the RFID tags.

10. The RFID tag communicating apparatus of claim 9, wherein the information communication control portion first performs the first communication through a command for reading a portion of identification information stored in the RFID tags and then performs the second communication through a command for reading the entire identification information stored in the RFID tags based on a result of the first communication.

11. The RFID tag communicating apparatus of claim 1, wherein the received signal processing portion whitens the received signals received by the plurality of the antennas and normalizes and orthogonalizes a restoring matrix determined based on the whitened signals to separate the return signals from a plurality of the RFID tags as independent components included in the received signals.
